(19) United States
(12) Patent Application Publication
(10) Pub. No.: US 2007/0101869 A1
(43) Pub. Date: May 10, 2007

(54) Portable rotisserie oven having a removable food holding device with an external handle

(76) Inventor: Jonathan D. Gelfand, Los Angeles, CA (US)

Correspondence Address: SNELL & WILMER LLP (OC), 600 ANTON BOULEVARD, SUITE 1400, COSTA MESA, CA, 92626, US

(21) Appl. No.: 11/267,878

(22) Filed: Nov. 4, 2005

(51) Int. Cl. A47J 37/04

(52) U.S. Cl. 99/419

(57) ABSTRACT

A rotisserie oven including a housing defining a cavity and having a slot, a heating element positioned within the cavity, a removable food holding device for holding food, and an external handle connected to the removable food holding device and positioned to fit through the slot when the removable food holding device is positioned within the cavity.

### FIELD OF THE INVENTION

The invention relates generally to portable cooking and heating devices, and more particularly to a portable rotisserie oven having a removable food holding device with an external handle.

### DESCRIPTION OF THE RELATED ART

Rotisserie cooking devices are used for cooking food articles such as meats and vegetables. Rotisserie cooking devices allow the food articles to be slowly cooked while the grease or fat is being drained off the food articles. Generally, the food articles are inserted through a front door and placed on a spit for cooking. The front door is closed to allow the food to be cooked. The food articles rotates on the spit while grease or fat is drained off.

Several drawbacks of conventional rotisserie cooking devices include difficulty in cleaning, difficulty in inserting and removing food articles, difficulty in moving and lack of ability to view the food articles as the food is being cooked.

Thus, it should be appreciated that there is a need for a portable rotisserie oven having a removable food holding device with an external handle. The invention fulfills these needs as well as others.

### SUMMARY OF THE INVENTION

In particular, and by way of example only, one embodiment of the invention is a rotisserie oven including a housing defining a cavity and having a slot, a heating element positioned within the cavity, a removable food holding device for holding food, and an external handle connected to the removable food holding device and positioned to fit through the slot when the removable food holding device is positioned within the cavity.

One embodiment of the invention is a rotisserie oven including a housing having a plurality of removable walls defining a cavity and having a slot, a heating element positioned within the cavity, a skewer for holding food, and an external handle connected to the skewer and positioned to fit through the slot when the skewer is positioned within the cavity.

One embodiment of the invention is a rotisserie oven including a housing having a plurality of removable walls defining a cavity and having a slot, a heating element positioned within the cavity, a basket for holding food, and an external handle connected to the basket and positioned to fit through the slot when the basket is positioned within the cavity.

These and other features and advantages of the embodiments of the invention will become apparent from the following detailed description, taken in conjunction with the accompanying drawings, which illustrate, by way of example, the principles of the invention.

### BRIEF DESCRIPTION OF THE DRAWINGS

FIG. 1 is a perspective view of a rotisserie oven having a housing defining a cavity for receiving a removable food holding device according to an embodiment of the invention;

FIG. 2 is a front view of the rotisserie oven of FIG. 1 according to an embodiment of the invention;

FIG. 3 is a top view of the rotisserie oven of FIG. 1 according to an embodiment of the invention;

FIG. 4 is a side view of the rotisserie oven of FIG. 1 according to an embodiment of the invention;

FIG. 5 is a cross-sectional front view of the rotisserie oven of FIG. 1 according to an embodiment of the invention;

FIG. 6 is a schematic view of the rotisserie oven of FIG. 1 according to an embodiment of the invention;

FIGS. 7 and 8 are perspective views of the removable food holding device, the external handle and the slot cover according to an embodiment of the invention;

FIGS. 9A, 9B and 9C are perspective views of a removable food holding device that includes a plurality of skewers and a cap according to an embodiment of the invention;

FIGS. 10A, 10B and 10C are perspective views of a removable food holding device that includes a sealed cylindrical basket and a cap for closing one end of the basket according to an embodiment of the invention; and

FIGS. 11A, 11B and 11C are perspective views of a removable food holding device that includes a meshed cylindrical basket and a cap for closing one end of the basket according to an embodiment of the present invention.

### DETAILED DESCRIPTION OF THE PREFERRED EMBODIMENTS

Devices and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

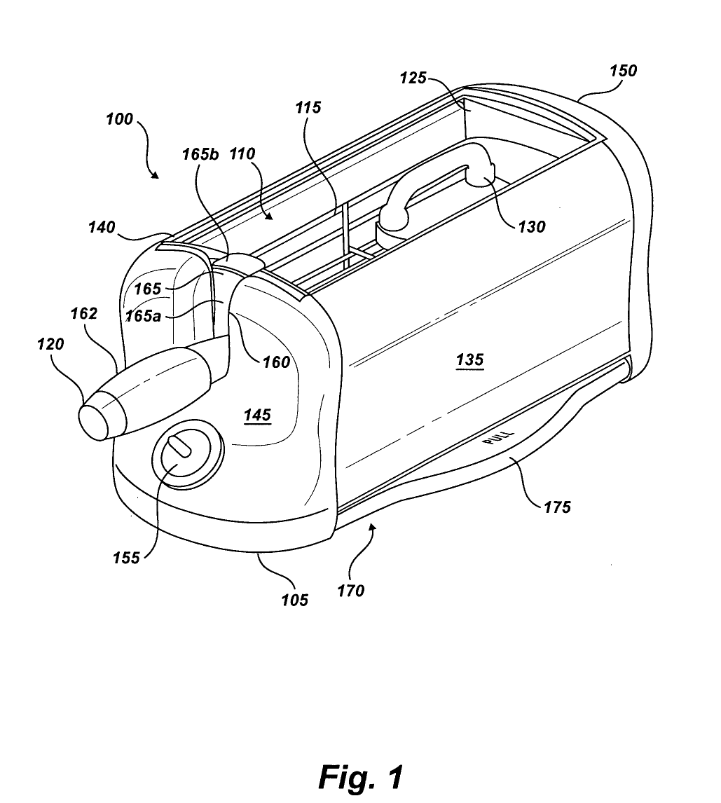

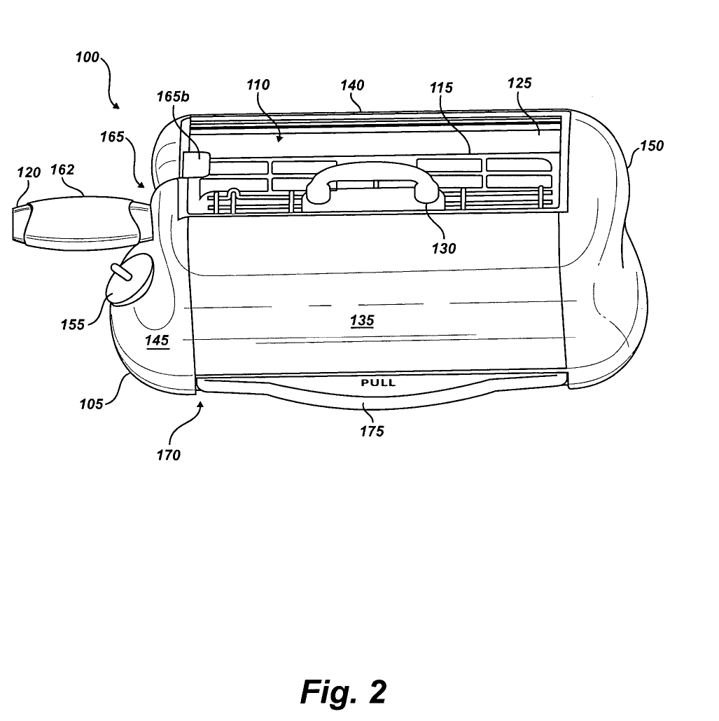

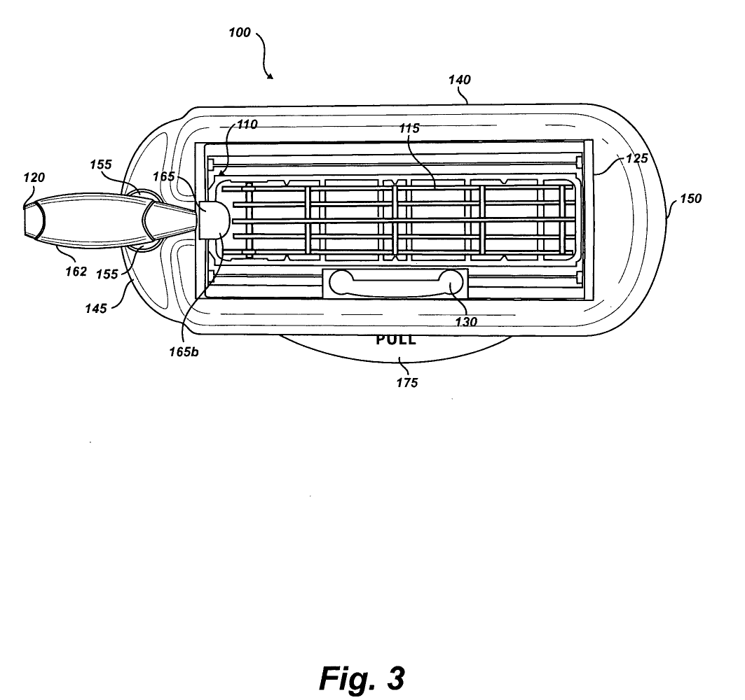

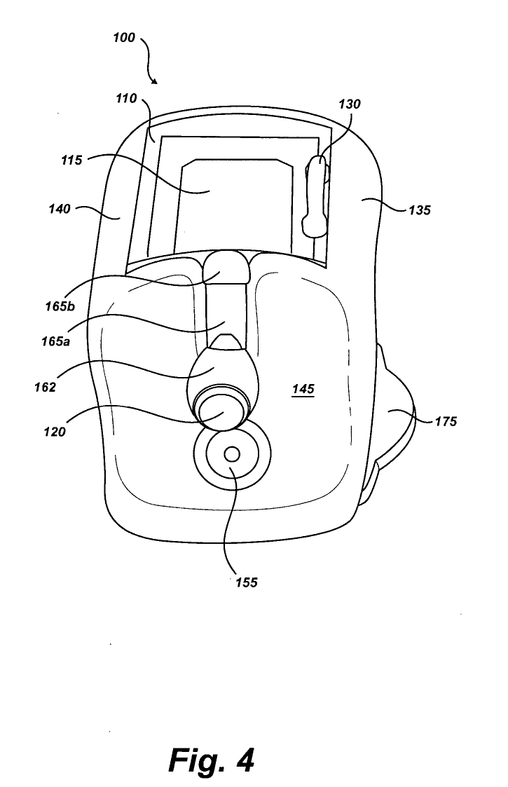

Referring now more particularly to the drawings, FIGS. 1-4 are perspective, front, top and side views respectively of a rotisserie oven 100 having a housing 105 defining a cavity 110 for receiving a removable food holding device 115. The removable food holding device 115 may be a basket, a skewer or any other device capable of holding or securing food. Food may be placed on or in the removable food holding device 115. The removable food holding device 115 has a first end 116 and a second end 117. The first end 116 is connected to an external handle 120 for making the rotisserie oven 100 much easier and safer to use. The second end 117 is connected to a motor (not shown) that is located in the housing 105 and that is used to rotate the removable food holding device 115 when it is positioned in the cavity 110. In one embodiment, the external handle 120 has a length of about 120 millimeters (mm). The removable food holding device 115 and the external handle 120 are washable and dishwasher safe.

The rotisserie over 100 may include a top cover 125 with a handle 130 that can be opened to allow the removable food holding device 115 to be inserted into and removed from the cavity 110. During cooking or heating of the food, the removable food holding device 115 may be placed in the cavity 110 and the top cover 125 may then be closed to retain the heat within the cavity 110. The top cover 125 can be made of a see-through material (e.g., glass) to allow a user to view the food while it is being cooked or heated. The top cover 125 is removable, washable and dishwasher safe.

The housing 105 may be formed in the shape of a rectangle and has a front portion 135, a rear portion 140, a left portion 145, and a right portion 150. In one embodiment, the housing 105 may have a length L of about 376 mm, a width W of about 160 mm, and a height H of about 170 mm. The rotisserie oven 100 may include a timer knob 155 to control the amount of time the heating elements (shown in Figure ) located inside the cavity 110 are operating. The timer knob 155 may be positioned on the left portion 145 of the housing 105.

The left portion 145 of the housing 105 may include a slot 160 positioned above the timer knob 155. The slot 160 may be a U-shaped slot, a V-shaped slot or any other shaped slot capable of receiving the external handle 120. The external handle 120 protrudes through the slot 160 and is located outside the cavity 110. Hence, a user may remove the removable food holding device 115 by grabbing the external handle 120 without a glove (if desired) and lifting straight up. Because the external handle 120 is located outside the cavity 110, it is not subject to heating like the removable food holding device 115. The external handle 120 may be made of an insulating material so that it does not heat up and may be covered with a gripable material 162 such as rubber to provide a non-slip surface.

A slot cover 165 may be attached to the external handle 120 and positioned to cover the slot 160 when the removable food holding device 155 is located within the cavity 110. The slot cover 165 is generally formed in the shape of the slot 160 so that the heat within the cavity 110 does not escape through the slot 160. The slot cover 165 may be made of a metallic material (e.g., aluminum) or an insulating material so that it does not heat up. In one embodiment, the slot cover 165 includes a first portion or plate 165a that extends upward from the external handle 120 to the top cover 125 and a second portion or plate 165b that extends inward toward the cavity 110. The slot cover 165 may also act as a support for the top cover 125.

The housing 105 may include an opening 170 that allows a removable drip tray 175 to slid into and out of the cavity 110. The removable drip tray 175 defines the bottom surface of the cavity 110 and is used to hold drippings (e.g., marinades, fat or grease) from the food or food that drops from the removable food holding device 115. The removable drip tray 175 is washable and dishwasher safe.

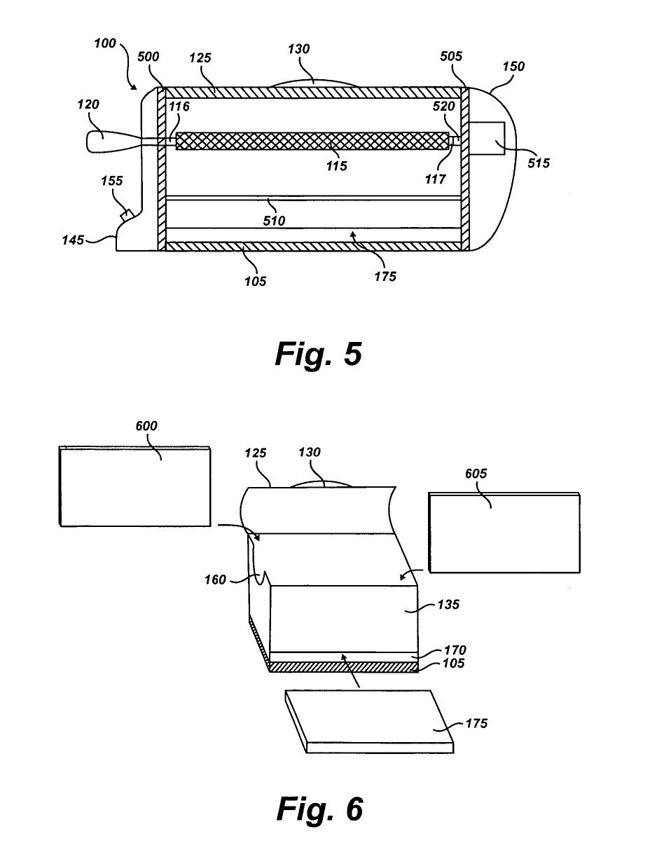

FIG. 5 is a cross-sectional front view of the rotisserie oven 100 of FIG. 1. In one embodiment, the rotisserie oven 100 may include removable inner walls 500 and 505 that are washable and dishwasher safe. The removable inner walls 500 and 505 are positioned within the cavity 110 and can be fastened to the housing 105. The removable inner walls 500 and 505 are made of a material (e.g., aluminum) that can withstand high oven temperatures. The rotisserie oven 100 includes one or more heating elements 510 positioned below the removable food holding device 115 and coupled to the removable inner walls 500 and 505. The amount of time the heating elements are on is determined by the setting of the timer knob 155. The timer knob 155 can also be used to automatically shut off the heating elements.

A motor 515 can be removably coupled to the inner wall 505 and can be used to rotate the removable food holding device 115 within the cavity 110. The external handle 120 generally does not rotate with the removable food holding device 155. The motor 515 may include a shaft 520 that is removably coupled to the second end 117 of the removable food holding device 115. In one embodiment, the motor 515 can rotate the removable food holding device 155 without the heating elements 510 being on. The timer knob 155 can also be used to automatically shut off the motor 515.

FIG. 6 is a schematic view of the rotisserie oven 100 of FIG. 1. In one embodiment, the rotisserie oven 100 may include removable inner walls 600 and 605 that are washable and dishwasher safe. The removable inner walls 600 and 605 are positioned within the cavity 110 and can be fastened to the housing 105. The removable inner walls 600 and 605 are made of a material (e.g., aluminum) that can withstand high oven temperatures.

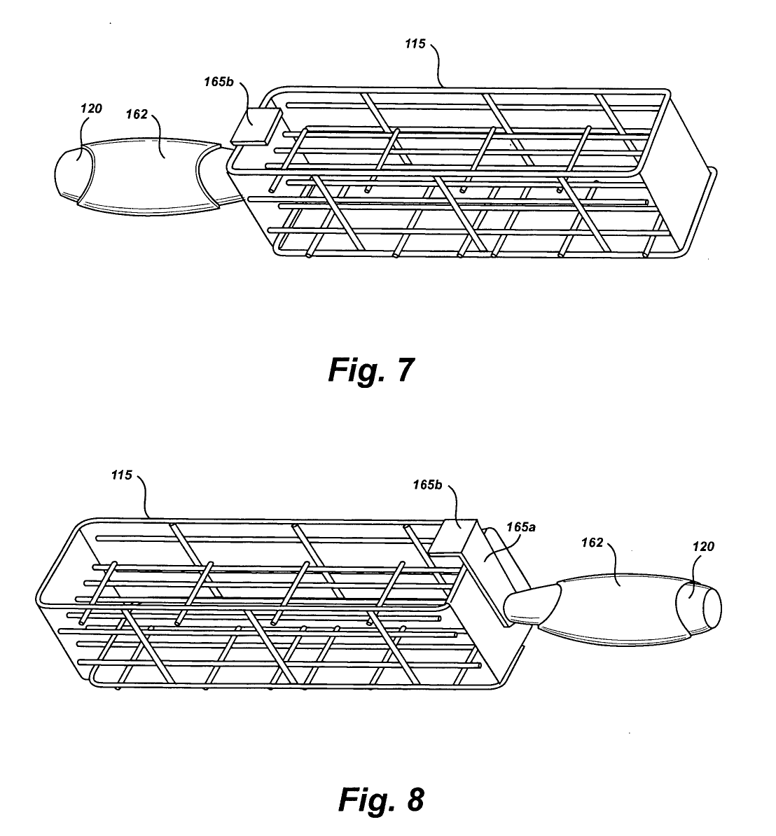

FIGS. 7 and 8 are perspective views of the removable food holding device 115, the external handle 120 and the slot cover 165. The removable food holding device 115 is shown as a wire basket where food can be placed inside the basket and can move around freely as the removable food holding device 115 rotates about a central axis. The wire basket can be configures for various types of food. That is, the wires can be close together for small food pieces and can be far apart for large food pieces.

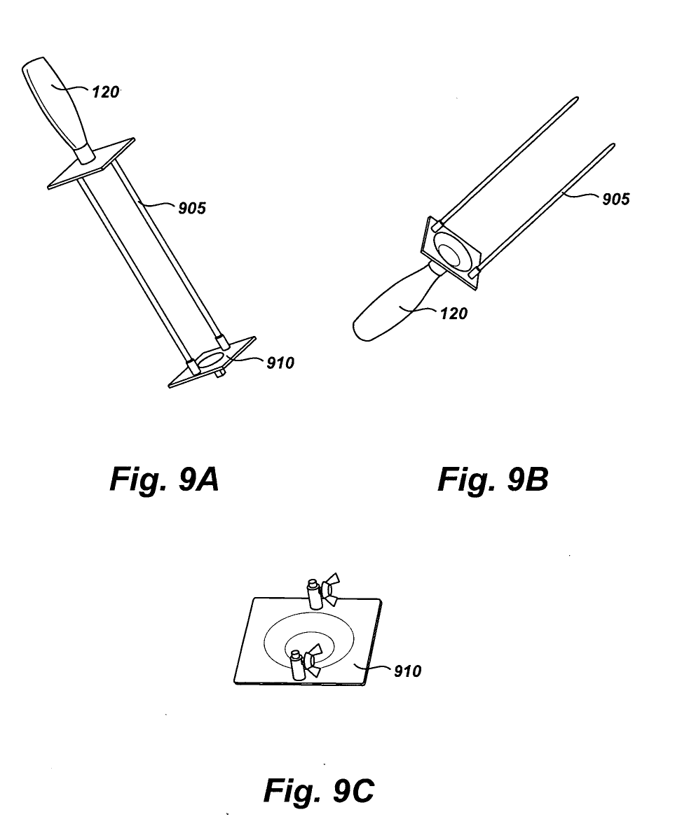

FIGS. 9A, 9B and 9C are perspective views of a removable food holding device 900 that includes a plurality of skewers 905 and a cap 910. The plurality of skewers 905 are used for holding food (e.g., chicken, fish, beef, vegetables, etc.) as it rotates within the cavity 110. After the food is stabbed with the skewers, the cap 910 is attached to the ends of the plurality of skewers 905.

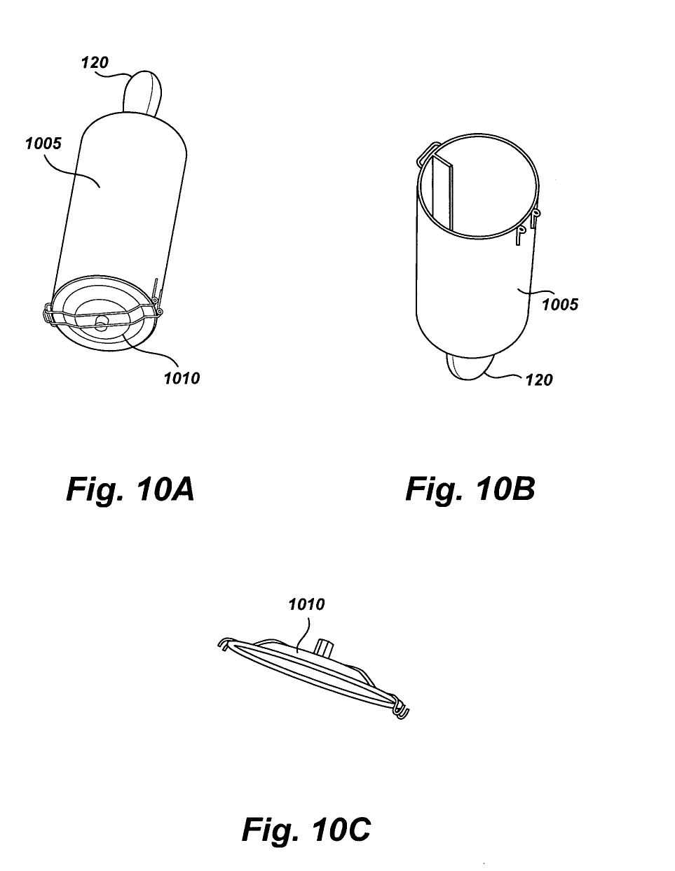

FIGS. 10A, 10B and 10C are perspective views of a removable food holding device 1000 that includes a sealed cylindrical basket 1005 and a cap 1010 for closing one end of the basket 1005. The cap 1010 can be secured to the sealed cylindrical basket so no food or juices within the basket 1005 can escape. The sealed cylindrical basket 1005 is used for holding food as it rotates within the cavity 110. The sealed cylindrical basket 1005 allows the food and any. juices to be cooked together within the basket. The sealed cylindrical basket 1005 is made of a conductive material so that the food inside the basket 1005 can be heated. The cylindrical shape of the basket allows the food to rotates therein.

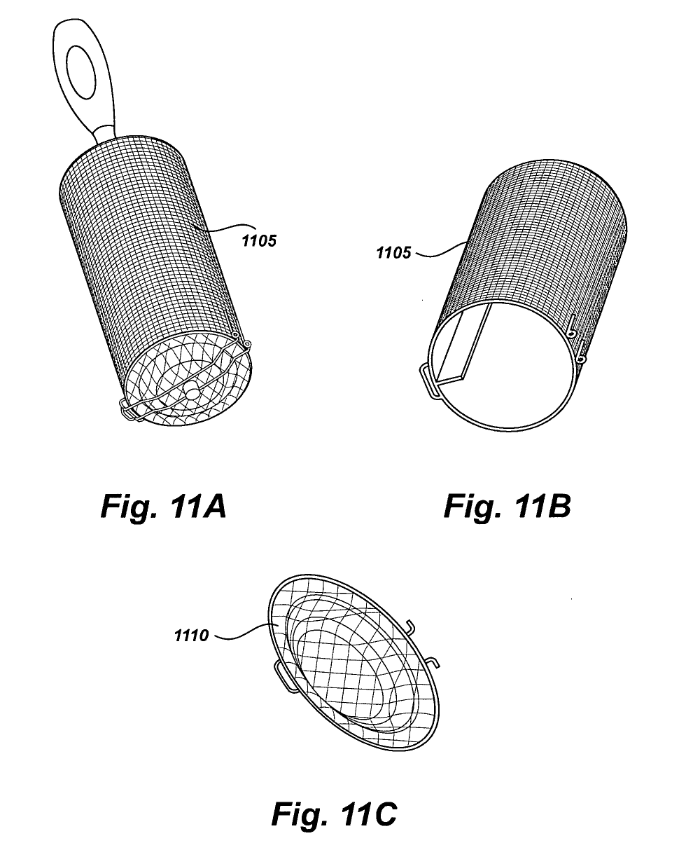

FIGS. 11A, 11B and 11C are perspective views of a removable food holding device 1100 that includes a meshed cylindrical basket 1105 and a cap 1110 for closing one end of the basket 1105. The cap 1110 can be secured to the meshed cylindrical basket 1105. The meshed cylindrical basket 1105 is used for holding food as it rotates within the cavity 110. The meshed cylindrical basket 1105 allows the food to be exposed to the heat through the holes in the basket 1105. The meshed cylindrical basket 1105 is made of a conductive material so that the food inside the basket 1105 can be heated. The cylindrical shape of the basket allows the food to rotates therein.

Although an exemplary embodiment of the invention has been shown and described, many other changes, combinations, omissions, modifications and substitutions, in addition to those set forth in the above paragraphs, may be made by one having skill in the art without necessarily departing from the spirit and scope of this invention. Accordingly, the invention is not intended to be limited by the preferred embodiments, but is to be defined by reference to the appended claims.

What is claimed is:

1. A rotisserie oven comprising:
a housing defining a cavity and having a slot;
a heating element positioned within the cavity;
a removable food holding device for holding food; and
an external handle connected to the removable food holding device and positioned to fit through the slot when the removable food holding device is positioned within the cavity.

2. The rotisserie oven of claim 1 wherein the slot is formed in the shape of a U.

3. The rotisserie oven of claim 1 wherein the slot is formed in the shape of a V.

4. The rotisserie oven of claim 1 wherein the removable food holding device is selected from a group consisting of a basket, a skewer, and a sealed container.

5. The rotisserie oven of claim 4 wherein the basket is a wire basket.

6. The rotisserie oven of claim 4 wherein the sealed container is a sealed cylindrical basket.

7. The rotisserie oven of claim 1 further comprising a slot cover attached to the removable food holding device for covering the slot.

8. The rotisserie oven of claim 1 further comprising a slot cover attached to the external handle for covering the slot.

9. The rotisserie oven of claim 1 further comprising a motor for rotating the removable food holding device.

10. The rotisserie oven of claim 9 further comprising a timer for controlling the amount of time the motor is on and automatically shutting off the motor.

11. The rotisserie oven of claim 1 further comprising a timer for controlling the amount of time the heating element is on and automatically shutting off the motor.

12. The rotisserie oven of claim 1 further comprising a plurality of removable walls positioned within the cavity.

13. A rotisserie oven comprising:
a housing having a plurality of removable walls defining a cavity and having a slot;
a heating element positioned within the cavity;
a skewer for holding food; and
an external handle connected to the skewer and positioned to fit through the slot when the skewer is positioned within the cavity.

14. The rotisserie oven of claim 13 wherein the slot is formed in the shape of a U.

15. The rotisserie oven of claim 13 wherein the slot is formed in the shape of a V.

16. The rotisserie oven of claim 13 further comprising a slot cover attached to the removable food holding device for covering the slot.

17. The rotisserie oven of claim 13 further comprising a slot cover attached to the external handle for covering the slot.

18. The rotisserie oven of claim 13 further comprising a motor for rotating the skewer.

19. The rotisserie oven of claim 18 further comprising a timer for controlling the amount of time the motor is on and automatically shutting off the motor.

20. The rotisserie oven of claim 13 further comprising a timer for controlling the amount of time the heating element is on and automatically shutting off the motor.

21. A rotisserie oven comprising:
a housing having a plurality of removable walls defining a cavity and having a slot;
a heating element positioned within the cavity;
a basket for holding food; and
an external handle connected to the basket and positioned to fit through the slot when the basket is positioned within the cavity.

22. The rotisserie oven of claim 21 wherein the slot is formed in the shape of a U.

23. The rotisserie oven of claim 21 wherein the slot is formed in the shape of a V.

24. The rotisserie oven of claim 21 further comprising a slot cover attached to the basket for covering the slot.

25. The rotisserie oven of claim 21 further comprising a slot cover attached to the external handle for covering the slot.

26. The rotisserie oven of claim 21 further comprising a motor for rotating the basket.

27. The rotisserie oven of claim 26 further comprising a timer for controlling the amount of time the motor is on and automatically shutting off the motor.

28. The rotisserie oven of claim 21 further comprising a timer for controlling the amount of time the heating element is on and automatically shutting off the heating element.

29. The rotisserie oven of claim 21 wherein the basket is selected from a group consisting of a wire basket, a sealed cylindrical basket, and a meshed basket.
